(19) United States
(12) Patent Application Publication
(10) Pub. No.: US 2015/0185992 A1
(43) Pub. Date: Jul. 2, 2015

(54) PROVIDING GEOLOCATED IMAGERY RELATED TO A USER-SELECTED IMAGE

(71) Applicant: GOOGLE INC., Mountain View, CA (US)

(72) Inventors: Andrew Ofstad, Mountain View, CA (US); Bernhard Seefeld, San Francisco, CA (US)

(73) Assignee: GOOGLE INC., Mountain View, CA (US)

(21) Appl. No.: 14/033,091

(22) Filed: Sep. 20, 2013

Related U.S. Application Data
(60) Provisional application No. 61/706,643, filed on Sep. 27, 2012.

(51) Int. Cl. G06F 3/0484

(52) U.S. Cl. CPC G06F 3/0484

(57) ABSTRACT

To obtain imagery geographically related to a user-selected image, a selection of an image being displayed via a user interface of a software application is received. The selected image depicts an identifiable geographic entity. At least metadata associated with the image is sent to a group of one or more servers via a communication network. A set of images of the geographic entity depicted in the selected image and generally matching a pose of the selected image are received, where the pose defines at least a camera location and an orientation of the camera with respect to the depicted geographic entity. Navigation and display of the images via a second software application, that operates independently of the first software application, are provided.

### FIELD OF DISCLOSURE

This disclosure relates to displaying information about imagery shown on a computer display, and more specifically, an interface for selecting an image and displaying similar images in a mapping application.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many software applications, especially web browsers and other networking applications, display photographs and other images. Often, these software applications provide only a limited view of the image (e.g., a thumbnail version for copyright reasons) and little, if any, information about the subject depicted in the image. A user may see an image of a landmark building on a web site, for example, without being able to explore an area surrounding the landmark building without performing an additional search. Moreover, a thumbnail image or the corresponding text sometimes does not even identify the depicted subject. Thus, a user who wishes to see a larger image or additional images may have to undertake a considerable number of steps to identify and/or locate the desired images.

### SUMMARY

In an embodiment of the techniques of the present disclosure, a computer-readable storage medium stores instructions for obtaining imagery geographically related to a user-selected image. When executed by one or more processors of a computing device, the instructions cause the computing device to receive a selection of an image being displayed via a user interface of a software application executing on the one or more processors, where the selected image depicts an identifiable geographic entity. The instructions further cause the computing device send at least metadata associated with the image to a group of one or more servers via a communication network and receive, from the group of one or more servers, a set of images of the geographic entity depicted in the selected image and generally matching a pose of the selected image. The pose defines at least a camera location and an orientation of the camera with respect to the depicted geographic entity. The instructions further cause the computing device to provide navigation and display of the set of images via another software application that operates independently of the first software application.

In another embodiment, a method in a network device for providing images geographically related to a user-selected image includes receiving, from a client device via a communication network, a selection of a photographic image and automatically processing the photographic image to determine (i) a geographic entity depicted in the photographic image, (ii) a geographic location of the depicted geographic entity, and (iii) a camera pose corresponding to positioning of a camera that captured the photographic image relative to the depicted geographic entity. The method further includes selecting, from an electronic database, a set of images depicting the same geographic entity and having an approximately same pose as the selected photographic image, and sending the set of images to the client device for presentation via a mapping application.

In another embodiment, a method in a computing device for providing geographically relevant images to a user includes providing an API for use by a first software application executing on the computing device, where the first software application invokes the API to specify a photographic image selected via a user interface of the first software application, and where the API sends at least metadata associated with the selected image to a group of one or more servers via a communication network. The method also includes receiving images of a geographic entity depicted in the selected image and generally matching a pose of the selected image, where the pose defines at least a camera location and an orientation of the camera with respect to the depicted geographic entity, and displaying the images via a second software application that operates independently of the first software application, including displaying each of the images in accordance with a respective pose.

In still another embodiment, a computer-readable storage medium stores instructions executable by a processor to perform a method providing presentation of images based on a selected image, where the method includes identifying images in one or more public image databases by pose, receiving an image reference via a network from a computer, determining a pose of the received image, selecting an image set of one or more images having poses similar to the pose of the image, and sending the image set to the computer for presentation via an application.

In still another embodiment, a system for providing presentation of images related by pose to a selected image may include a client device having a display, a memory, a processor, and a user interface, the client device having computer executable modules stored in the memory that when executed on the processor cause the client device to: execute a first application that displays an image associated with a location, receive a request for similar images via a user interface of the client device and send a message including a reference to the image requesting similar images. The client processor may receive a response containing one or more similar images and display the one or more similar images via a second application in a context of the location. The system may also include a server in two-way communication with the client device, the server having a display, a memory, a processor, and a user interface, the client device having computer executable modules stored in the memory that when executed on the processor cause the client device to receive the message from the client device, determine, using the reference, a subject matter of the image, identify a location associated with the image, identify one or more additional images having the subject matter of the image, and send the one or more images and the location to the client device.

### BRIEF DESCRIPTION OF THE DRAWINGS

FIG. 1 is a block diagram of an example communication system that implements the techniques of the present disclosure to provide related geolocated imagery in response to a user selecting an image via a software application;

FIG. 2 is a flow diagram of an example method for providing imagery related to a user-selected image, which may be implemented in a computing device illustrated in FIG. 1;

FIG. 3 depicts an example web page with a thumbnail image and a user interface element for requesting related image data, which the computing device of FIG. 1 may provide via a user interface;

FIG. 4 is an example interactive 3D environment which a mapping application can present in response to a user activating the user interface element of FIG. 2; and

FIG. 5 illustrates example photographs overlaying a digital map, which a mapping application can present in response to a user activating the user interface element of FIG. 2.

### DETAILED DESCRIPTION

A software system that implements the techniques of the present disclosure allows a user to specify an image of a distinctive structure (e.g., a famous bridge or building), a natural formation (e.g., a recognizable mountain or waterfall), or another identifiable geographic entity, and automatically receive related photographic imagery with a matching camera pose. The related photographic imagery depicts the geographic entity and/or the nearby locations. To provide such imagery, a group of one or more servers maintains an electronic database of geolocated photographic images annotated with pose information. The servers may receive these images from a variety of sources including users' submissions, cameras mounted on vehicles or low-flying airplanes, etc. Accordingly, the images can include conventional photographs as well as panoramic photographs. The servers may process each individual image to determine the location (e.g., latitude and longitude) at which the image was captured, apply suitable image recognition techniques to identify the geographic entity that is the subject of the photograph and determine the camera pose, annotate the image with the corresponding information, etc. to populate the electronic database.

In an example scenario, a web browser displays a web page that includes a low-resolution thumbnail image of a landmark building. The user right-clicks on the thumbnail image or otherwise activates a dialog box via which the user selects a function for retrieving related images. The web browser then transmits the thumbnail image and/or metadata associated with the thumbnail image (e.g., a URL link, a pre-generated tag describing the camera pose and the subject of the image) to the group of servers, which in response provides images of the same landmark building with generally similar poses. The web browser also launches a mapping application in an embedded window or in a separate window. The mapping application receives and displays the requested related imagery in 2D (e.g., overlaying a digital map) or 3D (e.g., in a virtual walk-through display). More generally, any software application capable of displaying an image can invoke an application programming interface (API) or otherwise include functionality for requesting imagery related by pose.

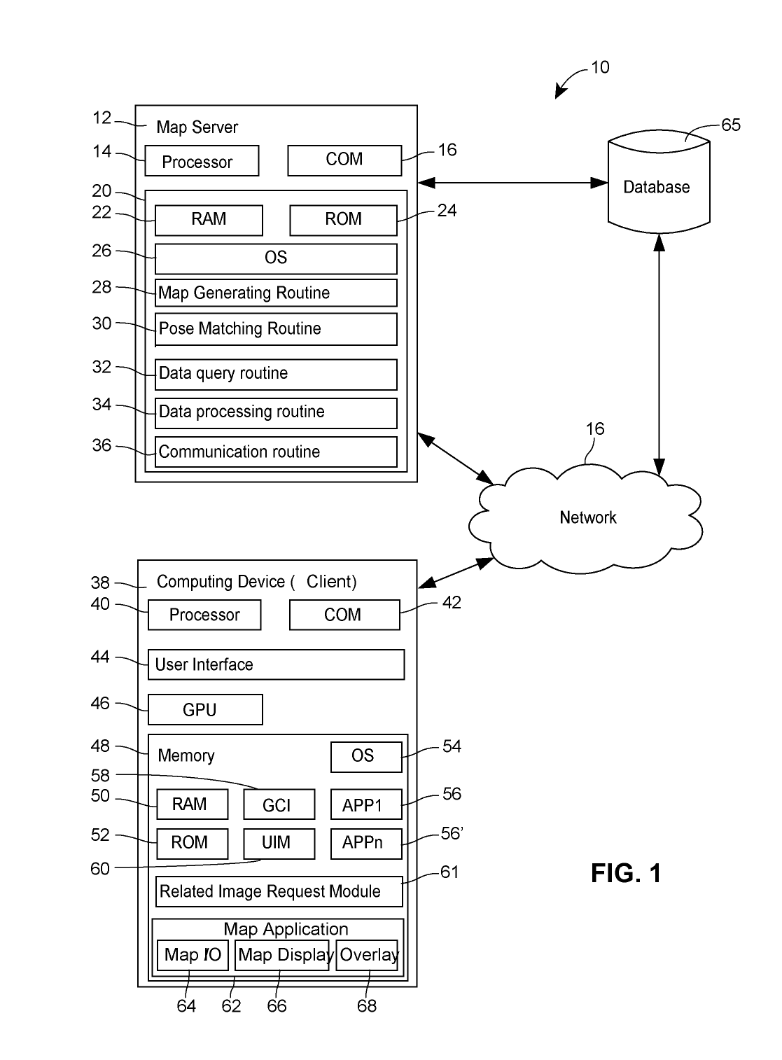

FIG. 1 illustrates an example communication system 10 capable of implementing some or all of the techniques for linking images by pose and providing geolocated imagery related to user-selected images. The map display system 10 includes a map server 12, which is shown to be a network device, e.g., computer. However, it is to be understood that the map server 12 may be any other suitable type of device, including, but not limited to, a main frame or a group of one or more operatively connected computers. The map server 12 includes various modules, which may be implemented using hardware, software, or a combination of hardware and software. The modules can include at least one central processing unit (CPU) or processor 14 and a communication module (COM) 16 capable of facilitating wired and/or wireless communication with the map server 12.

The map server 12 also includes a memory 20, which may be tangible, non-transitory memory and may include any types of memory modules capable of being incorporated in the map server 12, including random access memory 22 (RAM), read only memory 24 (ROM), and flash memory. Stored within the memory 20 is an operating system 26 (OS) and one or more applications or modules. The operating system 26 may be any type of operating system that may be executed on the map server 12 and capable of working in conjunction with the CPU 14 to execute the applications.

A map generating application or routine 28 generates a digital map in the form of raster tiles, vector graphics data, etc. for display on a screen. In some cases, the map generating routine 28 generates a 3D mesh to be textured using photographic images or other suitable description of 3D geometry for a geographic area. The map generating routine 28 is stored in memory 20 and may include additional routines or cooperate with additional routines to facilitate the generation and the display of map information, including routines for matching a camera pose to other photographic images having similar poses. The photographic images may be stored in an image database 65, or repositories accessible to the map server 12 that are operated as public image databases, for example. In general, these images can be conventional photographs, panoramic photographs, etc.

The additional routines may include a pose matching routine 30 that analyzes an image to identify the subject of the image (which may be a recognizable geographic entity such as a landmark building or natural formation) and determines the pose of the camera used to capture the image, according to one implementation. As one alternative, the pose matching routine 30 can determine the subject of the image and the camera pose using image metadata, such as a textual and/or numeric description of the camera pose and the subject depicted in the image, received from a client device. A data query routine 32 then can use the identified subject and camera pose to search for other images identified either by geolocation, image content, or metadata tags, etc., within the database 65 or on a network. The data query routine 32 also may use pre-programmed rules or heuristics to select a subset of the images available for selection and distribution to a client device 38 via a communication routine 36, which may control with the COM module 16. In addition to transmitting images related by pose to client devices, the communication routine 36 also may process requests for related images from the client devices.

Thus, for example, an image having a particularly unique set of characteristics (e.g., South Lawn of the White House) may be easily recognizable on its face using suitable image recognition techniques, including those known in the art. Additionally or alternatively, the image also may be annotated (or “tagged”) with information that helps with pose determination, such as “South Lawn of the White House.” Depending on the implementation, the tag may include various additional fields, such as a description of the camera pose, timestamp, etc. In some scenarios, the communication routine 36 receives, from a client device, a request for related images that includes a tag formatted similarly to the tags of images in the database 65. In other scenarios, the communication routine 36 does not receive image tags at all, and receives only images or links images.

In one implementation, a data processing routine 34 analyzes images submitted by users and/or automated sources to determine, when possible, the geographic entity depicted in the image and the camera pose, and generate a corresponding tag for each image. As indicated above, the tags may be stored with the images in the database 65.

With continued reference to FIG. 1, the client computing device 38 may be a stationary or portable device that includes a processor (CPU) 40, a communication module (COM) 42, a user interface (UI) 44, and a graphic processing unit (GPU) 46. The client computing device 38 also includes a memory 48, which may include any type of physical memory capable of being incorporated with or coupled to the client computing device 38, including random access memory 50 (RAM), read only memory 52 (ROM), and flash memory. Stored within the memory 48 is an operating system (OS) 54 and at least one application 56, 56′, both of which may be executed by the processor 40. The operating system 54 may be any type of operating system capable of being executed by the client computing device 36. A graphic card interface module (GCI) 58 and a user interface module (UIM) 60 are also stored in the memory 48. The user interface 44 may include an output module, e.g., a display screen and an input module (not depicted) such as a keyboard, mouse, trackball, touch screen, microphone, etc.

In one example implementation, the application 56 is a web browser that controls a browser window provided by the OS 54 and displayed on the user interface 44. During operation, the web browser 56 retrieves a resource, such as a web page, from a web server (not shown) via a wide area network (e.g., the Internet). The resource may include content such as text, images, video, interactive scripts, etc. and describe the layout and visual attributes of the content using HTML or another a suitable mark-up language. In general, the application 56 is capable of facilitating display of the map and photographic images received from the map device 12 on a screen.

The application 56 can include or invoke a related image request module 61, which may include software instructions implementing an API, for example. The related image request module 61 allows a user to select an image displayed by the application 56 and request related geolocated imagery having a similar pose.

The related image request module 61 may include compiled instructions or instructions that are interpreted at runtime, such as instructions in a scripting language. Moreover, in some implementations, the related image request module 61 is part of a web page received from a web content server. In this manner, a developer can include images or links to images in a web page and embed related image request module 61 in the web page to enable users to easily request related geolocated imagery with similar camera poses. Alternatively, a web browser (e.g., the application 56) can provide a menu option for activating the image request module 61.

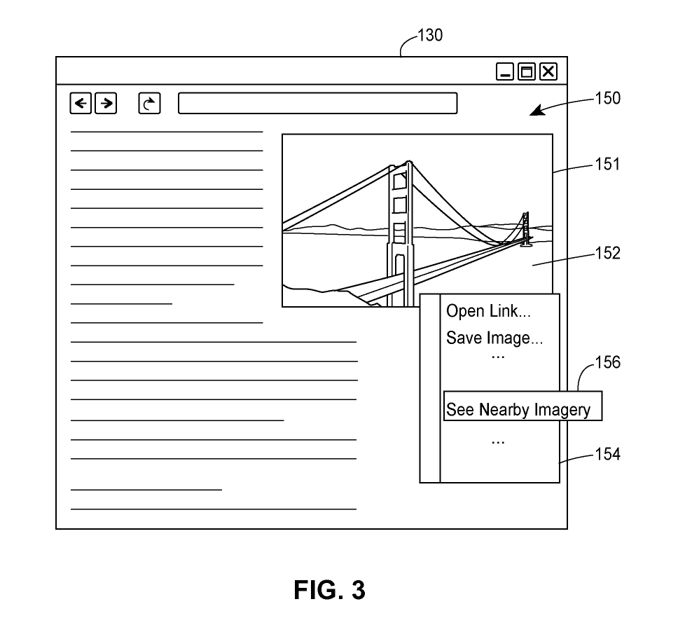

Turning briefly to FIG. 3, for example, a web browser executing on the client device 38 may display an example web page 150 in a window 130. The web page 150 includes text content and a low-resolution thumbnail image 152 depicting the Golden Gate Bridge. More specifically, the thumbnail image 152 may be displayed within a window 151. When a user right-clicks on the window 151, the web browser displays an interactive menu 154 including an item 156. If the user selects the item 156, the web browser activates the image request module 61 which generates a request for related imagery. More generally, any suitable user interface element may be used to present the option of requesting related imagery to the user.

Returning to FIG. 1, the application 56 thus may execute the image request module 61 to transmit image information to the map server 12, where map data and images with a similar pose may be assembled and sent to the computing device 38. Upon receipt of the map data and image or images, the image request module 61 may activate another window using either another browser instance 56′ or a mapping application 62, for example. The mapping application 62 may be stored in the memory 48 and may also include a map input/output (I/O) module 64, a map display module or routine 66, and an overlay module 68. The overlay module 68 of the mapping application 62 may be in communication with the UIM 60 of the client device 38. The map input/output routine may be communicatively coupled to the image request module 61 or may be directly instructed to receive the map and image data responsive to the request made via the image request module 61.

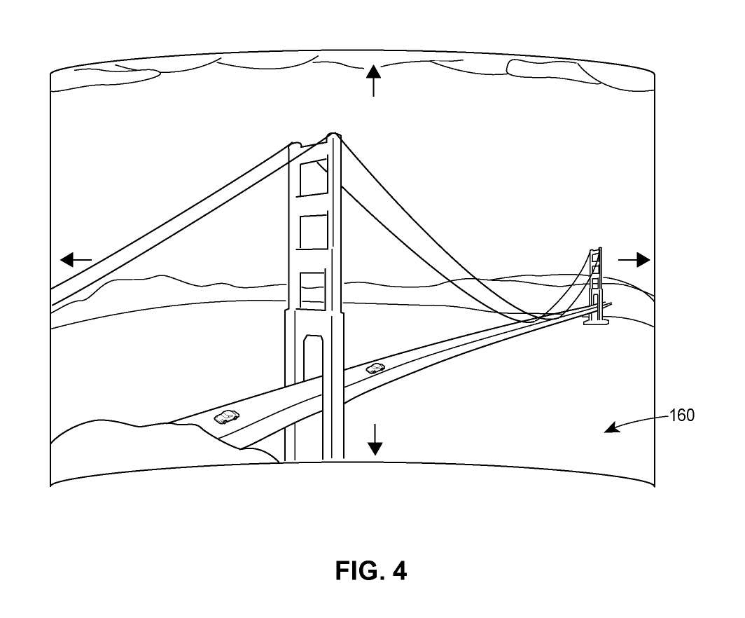

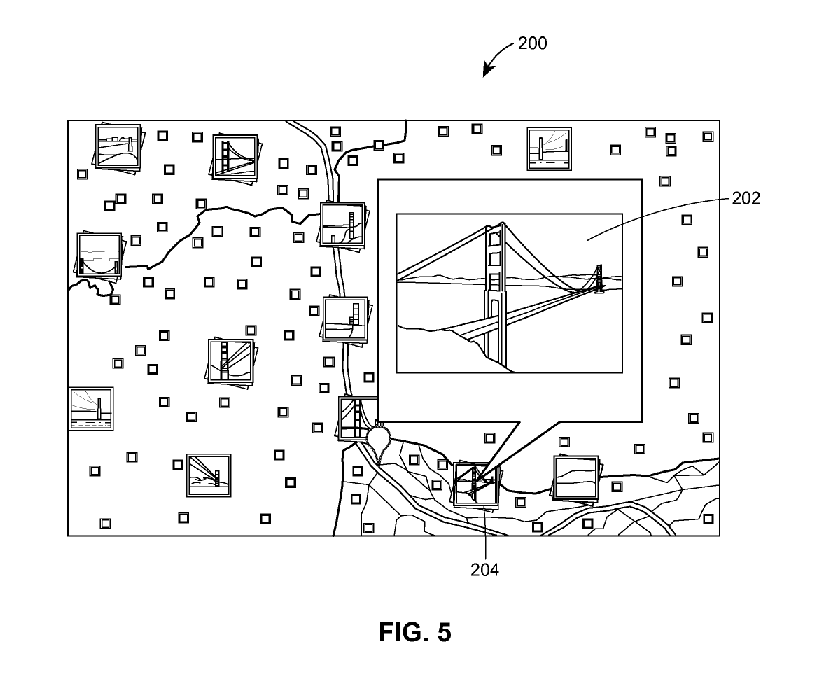

The map display module 66 may generate a map responsive to the data received from the server 12 and may use an overlay box routine 68 to present related geolocated images found at the server 12. These images may be displayed in any suitable manner, including in a 3D view, in a strip adjacent to, or overlaying, a digital map, in a slideshow mode, etc. FIGS. 4 and 5 provide examples of such display.

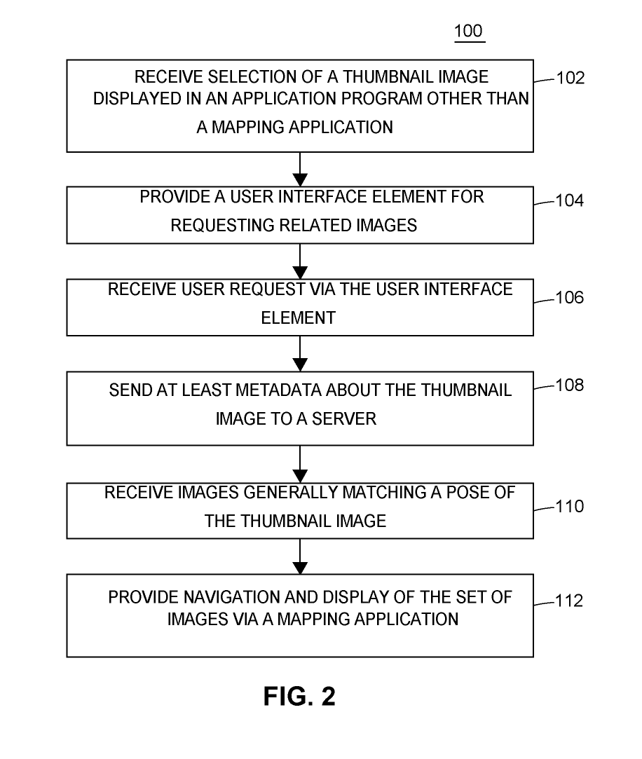

Referring to FIG. 4, a view 160 may include one or more images displayed in an interactive 3D environment in which a user can virtually walk, drive, or fly through a scene. In response to the user activating the related image request module 61 (or a similar module), a mapping application automatically receives imagery related by subject and pose and generates the view 160. In general, the view 160 may be made up of a panoramic photograph, a set of such photographs, a photo-textured 3D mesh, etc. To continue with the example of FIG. 2, in which the user selected an image depicting the Golden Gate Bridge from a particular vantage point, the view 360 presents the Golden Gate Bridge from the same or similar vantage point corresponding to the same or similar camera pose.

The user can navigate the scene to inspect the nearby scenery. Thus, rather than searching for images and looking at individual images at multiple web sites, or invoking a mapping application and trying to locate the same view of the Golden Gate Bridge, the user can quickly and efficiently inspect the geographic area surrounding the subject of a photograph.

Further, as illustrated in FIG. 5, a mapping application (such as the application 56) in another scenario may display a two-dimensional digital map 200 in response to a user activating the related image request module 61. The mapping application displays expandable thumbnail images over the digital map 170 at the approximate locations where these images were captured. More particularly, the mapping application determines which images to display over the digital map 200 based on the subject of the image selected via the module 61 and the pose of the selected image. For example, images 204 may be user-submitted photographs with the matching subject and an at least approximately patching camera pose. Once selected, an image may be displayed as a relatively large, high-resolution image. For example, an image 202 is selected and displayed in this manner in FIG. 5. In addition to being able to select and inspect in detail the images 203, the user can explore the nearby imagery corresponding to the same geographic entity or nearby entities.

FIG. 2 is a flow diagram of an example method 100 for providing imagery related to a user-selected image. The method 100 may be implemented as instructions stored on a computer-readable medium and executable by one or more processors. As one example, the method 100 can be implemented in the related image request module 61.

At block 102, a thumbnail image is displayed in a software application. For example, as illustrated in FIG. 3, the image 152 can be displayed in the window 130 of a web browser. In that case, a user may have an interest in the image 152 but the web page 150 may not have a descriptive text, a hyperlink, or other information to give the user a clue as to the subject of the image or where to find additional images. More generally, however, a software application of any kind (e.g., a word processing application, a graphics editing application) can display an image in any resolution.

At block 104, a user interface element for requested related geolocated imagery with similar camera poses is provided. The user interface element can be a dialog box, an icon, a button, etc. A confirmation of the selection is received at block 106. For example, the user can click or tap on the corresponding button. Other user interface elements may be used to accomplish this sequence, or one or more steps may be collapsed to save interactions on the part of the user.

Next, at block 108, at least metadata related to the selected image is sent to a server or a group of servers, such as the map server 12 illustrated in FIG. 1. The metadata may include camera pose information, such as the camera location and orientation, and in some cases may include a URL of the thumbnail image, a URL of a web page, etc. as an alternative or in addition to the camera pose information. According to yet another implementation, the actual thumbnail image is sent to a server.

Once a server receives the request generated at block 108, the server uses the received information to determine a pose of the image through direct matching or through heuristics associated with an implied location and subject matter of the image. Once one or more images have been identified and selected, the server may rank the images by characteristics the quality of the pose match, image characteristics such as color depth, clarity, etc., or by user ratings or some other criteria. If needed, the selection of images based on rank may be used when there are too many images of a popular subject with the generally matching camera pose. The top ranking images may be sent to the device that implements the method 100, such as the computing device 38. If no suitable images could be found, a message indicating the lack of additional images may be sent to the computing device. Additionally, map information for one or more map types may be assembled based on the geographic location of the subject of the selected image to allow the mapping application at the computing device to present the images in a geographical context.

The geolocated imagery is received at block 110. Then, at block 112, the mapping application provides navigation and display of the received geolocated imagery, as discussed with reference to FIGS. 4 and 5, for example.

As indicated above, the techniques discussed above may be implemented as computer programs stored on a tangible, non-transitory computer-readable medium (such as one or several hard disk drives) and executable on one or several processors. Although the methods described above can be executed on individual computers, such as servers or personal computers (PCs), it is also possible to implement at least some of these methods in a distributed manner using several computers, e.g., using a cloud computing environment.

Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for annotating images, providing geolocated images related to a selected image by subject and pose, and presenting such images on a computing device. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-readable storage medium having stored thereon instructions for obtaining imagery geographically related to a user-selected image, wherein the instructions, when executed by one or more processors of a computing device, cause the computing device to:
receive a selection of an image being displayed via a user interface of a first software application executing on the one or more processors, wherein the selected image depicts an identifiable geographic entity;
send at least metadata associated with the image to a group of one or more servers via a communication network;
receive, from the group of one or more servers, a set of images of the geographic entity depicted in the selected image and generally matching a pose of the selected image, wherein the pose defines at least a camera location and an orientation of the camera with respect to the depicted geographic entity; and
provide navigation and display of the set of images via a second software application that operates independently of the first software application.

2. The computer-readable storage medium of claim 1, wherein the geographic entity depicted in the selected image is an artificial structure or a natural formation automatically identified at the group of one or more servers.

3. The computer-readable storage medium of claim 1, wherein:
the instructions that cause the computing device to receive the selection of the image and send at least the metadata are included in an Application Programming Interface (API) invokable by the first software application, and
the instructions that cause the computing device to receive the images and provide navigation are provided as a function of the second software application.

4. The computer-readable storage medium of claim 3, wherein:
the first software application is a web browser, and
the second software application is a mapping application.

5. The computer-readable storage medium of claim 4, wherein the instructions that provide the navigation and the display of images provide the navigation and the display of images in an interactive three-dimensional (3D) environment presented by the mapping application.

6. The computer-readable storage medium of claim 1, wherein:
the first software application is a web browser configured to display web content retrieved via the communication network, and
the instructions that cause the computing device to receive the selection of the image and send at least the metadata are included in the web content.

7. The computer-readable storage medium of claim 1, including further instructions that, when executed on the one or more processors, provide a dialog box via the user interface offering a user to request the set of images, wherein the at least metadata is sent in response to the user requesting the set of images using the dialog box.

8. The computer-readable storage medium of claim 1, wherein:
the image displayed via the user interface of the first software application is a low-resolution thumbnail image,
the received set of images includes one or more high-resolution images.

9. The computer-readable storage medium of claim 1, wherein the instructions, when executed on the one or more processors, further cause the computing device to send the image to the group of servers.

10. The computer-readable storage medium of claim 1, wherein the instructions, when executed on the one or more processors, cause the computing device to send a Universal Resource Locator (URL) that references the image on a web page.

11. A method in a network device for providing images geographically related to a user-selected image, the method comprising:
receiving, from a client device via a communication network, a selection of a photographic image;
automatically processing the photographic image to determine (i) a geographic entity depicted in the photographic image, (ii) a geographic location of the depicted geographic entity, and (iii) a camera pose corresponding to positioning of a camera that captured the photographic image relative to the depicted geographic entity;
selecting, from an electronic database, a set of images depicting the same geographic entity and having an approximately same pose as the selected photographic image; and
sending the set of images to the client device for presentation via a mapping application.

12. The method of claim 11, wherein the set of images is configured to be displayed in an interactive 3D view of the geographic location.

13. The method of claim 11, further comprising:
receiving a plurality of photographic images of the depicted geographic entity from multiple sources;
automatically annotating the plurality of photographic images, including analyzing the plurality of images to determine respective camera poses; and
storing the determined camera poses with the plurality of images in the electronic database.

14. The method of claim 11, wherein receiving the selection of the photographic image reference includes one of:
receiving a URL link to the photographic image, or
receiving a row-resolution thumbnail version of the photographic image.

15. The method of claim 1, wherein the depicted geographic entity is landmark structure.

16. The method of claim 1, wherein the camera pose corresponds to (i) location information including latitude and longitude values (ii) a rotation metric, (iii) a pitch metric, and (iv) a field of view indication.

17. A method in a computing device for providing geographically relevant images to a user, the method comprising:
providing an API for use by a first software application executing on the computing device, wherein the first software application invokes the API to specify a photographic image selected via a user interface of the first software application, and wherein the API sends at least metadata associated with the selected image to a group of one or more servers via a communication network;
receiving a plurality of images of a geographic entity depicted in the selected image and generally matching a pose of the selected image, wherein the pose defines at least a camera location and an orientation of the camera with respect to the depicted geographic entity; and
displaying the plurality of images via a second software application that operates independently of the first software application, including displaying each of the plurality of images in accordance with a respective pose.

18. The method of claim 17, wherein displaying the plurality of images via a second software application includes:
displaying one of the plurality of images with a pose most closely matching the pose of the selected image, and
providing navigation controls for viewing the plurality of images in an interactive 3D environment.

19. The method of claim 17, further comprising retrieving a web page from a web server, wherein the API is invoked by a script included in the web page.

20. The method of claim 17, wherein the API sends a URL to the selected image to the group of servers.
